(19) United States
(12) Patent Application Publication
(10) Pub. No.: US 2007/0111072 A1
(43) Pub. Date: May 17, 2007

(54) Indicator fixed ion-exchange membrane

(76) Inventors: Ryan Wayne, Brecksville, OH (US); David Kaschak, Olmsted Falls, OH (US)

Correspondence Address: WADDEY & PATTERSON, P.C., 1600 DIVISION STREET, SUITE 500, NASHVILLE, TN, 37203, US

(21) Appl. No.: 11/273,629

(22) Filed: Nov. 14, 2005

(51) Int. Cl. H01M 8/10; C08J 5/22

(52) U.S. Cl. 429/33; 521/27; 429/90

(57) ABSTRACT

The invention comprises a novel method for creating an indicator fixed ion-exchange membrane, the indicator fixed ion-exchange membrane and a fuel cell testing device utilizing the novel membrane. The method for creating the indicator fixed membrane includes dissolving the indicator in a solvent, contacting an ion-exchange membrane with the indicator-solvent solution, and fixing the indicator of the combined solution and membrane to create an indicator fixed ion-exchange membrane. The claimed membrane product includes an indicator fixed ion-exchange membrane created by the above method. A fuel cell testing device using the novel membrane is both a cost efficient and effective means for determining at least one fuel cell component characteristic.

### FIELD OF THE INVENTION

The invention relates generally to fuel cells and particularly to the construction and use of an indicator fixed ion-exchange membrane for evaluating individual components of a fuel cell and assemblies of two or more components of the fuel cell.

### TECHNICAL BACKGROUND

An ion exchange membrane fuel cell, more specifically a proton exchange membrane (PEM) fuel cell, produces electricity through the chemical reaction of hydrogen and oxygen in the air. Within the fuel cell, electrodes, denoted as anode and cathode, surround a polymer electrolyte to form what is generally referred to as a membrane electrode assembly, or MEA. Oftentimes, the electrodes also function as the gas diffusion layer (“GDL”) of the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell includes a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

The flow field plates have a continuous reactant flow channel with an inlet and an outlet. The inlet is connected to a source of fuel in the case of an anode flow field plate, or a source of oxidant in the case of a cathode flow field plate. When assembled in a fuel cell stack, each flow field plate functions as a current collector.

Electrodes, also referred to as gas diffusion layers, may be formed by providing a graphite sheet as described herein and providing the sheet with channels, which are preferably smooth-sided, and which pass between the parallel, opposed surfaces of the flexible graphite sheet and are separated by walls of compressed expandable graphite. It is the walls of the flexible graphite sheet that actually abut the ion exchange membrane, when the inventive flexible graphite sheet functions as an electrode in an electrochemical fuel cell.

The channels are formed in the flexible graphite sheet at a plurality of locations by mechanical impact. Thus, a pattern of channels is formed in the flexible graphite sheet. That pattern can be devised in order to control, optimize or maximize fluid flow through the channels, as desired. For instance, the pattern formed in the flexible graphite sheet can comprise selective placement of the channels, as described, or it can comprise variations in channel density or channel shape in order to, for instance, equalize fluid pressure along the surface of the electrode when in use, as well as for other purposes which would be apparent to the skilled artisan.

The aforementioned PEM fuel cells are being developed as an alternative energy source for portable, stationary, and industrial applications. Significant R&D efforts in the fuel cell area are being directed towards the science of fuel cell technology as well as in the areas of engineering and systems integration. A common need at the heart of all PEM systems is to increase the understanding of molecular level interactions within the system including gas flow to the membrane electrode assembly (“MEA”), diffusion, kinetics, thermodynamics of reactants and products of the electrochemical reaction, water management, heat transfer, and current collection.

Presently, diagnostic systems like fuel cell test stations are available which allow performance testing of stack-level component integration, combined with electronic measurements for performance evaluations, these systems are very costly, complex, and time consuming to operate. Additionally, individual component characterization and material evaluation is potentially possible through the use of classic electrochemical, and materials characterization methodologies such as X-ray diffraction, Potentiostatic/Galvanostatic measurements, impedance analysis, and microscopy.

As an example of industry shortcomings in the testing regime, Gurley porosity is commonly utilized to give an indication of the permeability of a fuel gas (e.g., hydrogen) through gas diffusion layer substrates. While Gurley porosity is useful for initial material screening purposes, direct correlation to operational performance is difficult. Also Gurley porosity does not include any specificity towards a correlation with the electrochemical reaction that takes place at the anode or cathode. Furthermore, localized differences in gas diffusion rates are difficult to detect.

There is a lack of availability of intermediate testing paradigms that elucidate material and component integration, below the stack-level or even single cell level integration (ex-situ). Also there is need for a membrane which would assist in evaluating component performance functions under conditions that simulate real fuel cell operation. Furthermore, there is a need for an ion-exchange membrane which would assist in testing without requiring a substantial exchange or addition of components to the fuel cell. Furthermore again, there is a need for a quick cost-effective testing paradigm for components.

### SUMMARY OF THE INVENTION

One aspect of the invention is a method of creating an indicator fixed ion-exchange membrane. The method includes treating the membrane with an indicator solution and subsequently absorbing the indicator solution into the membrane. Furthermore, this method can include membrane hydrolysis where the indicator fixed membrane is stirred in a hydrolyzing solution, washed and dried. Another aspect of the invention is an indicator fixed ion-exchange membrane. The indicator is either adsorbed into the membrane or physically attached within the membrane by covalent bonding. The indicator will provide a visual indication of a concentration gradient in the ion-exchange membrane.

Yet another aspect of the invention is a fuel cell testing device. The device includes an entrance port for the input flow of fluid capable of undergoing an oxidation or reduction. The apparatus further includes a housing capable of receiving at least one fuel cell component and also the ionizable fluid. Additionally, the apparatus includes an indicator fixed membrane in communication with the assembly which provides an indication of at least one fuel cell component characteristic.

One advantage of the invention includes the ability to visualize the gas diffusion activity in ion-exchange half-cell reactions. In an embodiment of the invention, this is accomplished via a novel integration of an indicator such as a fluorescent pH detection or a calorimetric dye with the ion-exchange membrane.

Another advantage of this invention is that no additional physical elements beyond the standard components of a fuel cell are required to investigate a characteristic of a fuel cell component. In an embodiment, the indicator fixed membrane provides a luminescent or colorimetric signal as to the characteristic of one or more fuel cell components.

Another advantage of the invention is that the invention can be used to focus on parameters related to spatial visualization of gas diffusion, catalyst uniformity verification, and fuel delivery through gas diffusion layer(s) to the catalyst based on the visual concentration gradient of the indicator fixed ion-exchange membrane.

A further advantage of the invention is that it may be practiced to test various components of a fuel cell, individually or in combination with each other, at conditions that mimic the operating conditions of the fuel cell.

Additionally, the invention will accelerate the state of the art understanding of component functions within an operating fuel cell, and provide a tool to assist in rapidly commercializing the fuel cell through optimized component integration.

Additional features and advantages of the invention will be set forth in the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a side schematic representation of a fluid diffusion testing apparatus.

FIG. 2 is a top view of an indicator having at least one area of changed acidity.

FIG. 3 is a schematic side elevation view of the alignment of a half-cell electrode assembly 16, and an indicator fixed ion-exchange membrane 18 in accordance with the invention.

FIG. 4 is a top view of indicator fixed ion-exchange membrane 18 depicted in FIG. 3.

FIGS. 5 and 6 comprise two top views of indicator fixed ion-exchange membrane 18 which each include a respective concentration gradient of sample in indicator fixed ion-exchange membrane 18.

### DETAILED DESCRIPTION OF THE INVENTION

Indicator fixed ion-exchange membranes in accordance with the present invention are prepared by combining a polymeric membrane with a visual concentration gradient indicator. Suitable polymeric membranes include thin sheets of perfluorinated sulfonic acids derived from fluorinated styrenes, quaternary amine polystyrene, polybenzimidazole (“PBI”), or other ionomeric polymers. Preferably, the membrane comprises a solid polymer electrolyte (also referred to as a solid polymer ion exchange membrane) that is an electrically insulating material. More preferred the insulating material is substantially gas-impermeable and substantially ion-permeable.

As for properties, it is preferred that the membrane has excellent mechanical strength, predictable dimensional changes, low electrical conductivity, and the ability to transport the desired ions while rejecting the undesired ions and molecules. Preferably the inventive membrane is in communication with the housing so that matter may flow into housing and at least the desired material, (ions or reduced species) may pass into the indicator fixed membrane.

With respect to the membrane, examples of suitable membrane materials include, but are not necessarily limited to, NAFION® products available from Dupont of Wilmington, Del., the Dow membrane materials available from Dow Chemical Co., of Midland, Mich., the Gore-Select™ materials available from W.L. Gore & Associates, Inc, of Wilmington, Del. and the like.

For additional background regarding the catalyst, the fluid permeable element, the membrane, or other basic elements of an electrochemical fuel cell, the specifications of U.S. Pat. Nos. 4,988,583 and 5,300,370 and PCT WO 95/16287 are incorporated herein by reference in their entirety. Furthermore, for additional background information regarding a multi-component fuel cell testing device and methods of detecting an ionic gradient, the specification of U.S. Pat. No. 6,841,387 is incorporated herein by reference in its entirety.

Polymer electrolyte membranes are solid with the polymers from which they are composed containing side chains that terminate in functional groups. These functional groups tend to organize into interconnected clusters, which provide the membrane with its ion-conductive and hydrophilic properties. During indicator-fixation, the membrane absorbs an organic solvent into which the indicator molecules have been dissolved. This solvent penetrates the entire volume of the membrane and causes the hydrophilic clusters to swell. When the solvent is rinsed out of the membrane, some of the indicator comes out of solution and remains immobilized in the membrane. The resulting membrane is indicator-adsorbed as the indicator is adsorbed to the internal surfaces of the membrane's ion channels.

The indicator is selected from a variety of dyes and luminescent chemicals to signal the specific permeation of a desired material (ions or reduced species) by means of the indicator fixed ion-exchange membrane. A variety of indicators and their means of signaling a concentration gradient are discussed below.

In one embodiment, the indicator fixed ion-exchange membrane is created through the adsorption of 3-(2-pyridyl)-[1,2,3]-triazolo [1,5a]pyridine (PTP) onto a perfluorocarbonsulfonic acid-based ionomer membrane. The PTP indicator is created through a two step reaction, the first reaction synthesizing dis-2-pyridyl ketone hydrazone (PKH). Dis-2-pyridyl ketone is dissolved and subsequently reacted with hydrazine monohydrate. This reaction product is later recrystallized and dried to create the PKH. The second step of the PTP indicator production includes the reaction of PKH with cupric nitrate trihydrate. After both an extraction and evaporation, the newly created PTP indicator is dried at room temperature to prepare the PTP for an ion-exchange membrane.

To fix the PTP onto an ion-exchange membrane, PTP is dissolved in methyl chloride followed by the addition of 3,3-dichloro-1,1,1,2,2-pentafluoropropane, and 1,3-dichloro-1,1,1,2,3-pentrfluoropropane (Asahiklin AK-225®). The mixture is stirred for at least five minutes to obtain a clear dye solution before transferring to a reaction vessel. The membrane is then cut and immersed into the dye solution contained in the reaction vessel. Subsequently, the reaction vessel is sealed and heated at 30° C. The PTP adsorbed membrane is then washed with methylene chloride to remove excess dye from the membrane. Finally, the membrane is dried at room temperature and positioned to promote uniform drying.

In another embodiment quinine may be fixed to an ion-exchange membrane using a protocol similar to the protocol for creating the PTP fixed membrane. Following the creation of either the PTP fixed ion-exchange membrane or the quinine fixed ion-exchanged membrane, the indicator fixed membranes can undergo a hydrolysis treatment to be conditioned for use in commercial applications.

The first step of the hydrolysis treatment includes the complete mixing of aqueous sodium hydroxide with dimethyl sulfoxide (DMSO). Subsequently, the indicator fixed ion-exchange membrane is immersed in the solution and gently stirred. Additional DMSO is then added to the membrane and mixture followed by further gentle stirring. Afterwards, the membrane was repeatedly washed with distilled water to remove the excess base, and the membrane was dried at room temperature. During drying, the indicator fixed ion-exchange membrane was held flat to promote uniform shrinkage.

In a specific embodiment, the invention is the actual indicator fixed ion-membrane product. With the correct solvent, practically any dye could be put into the membrane. In one variation, the invention comprises a fluorescent pH indicator fixed onto the ion-exchange membrane. Preferred types of the fluorescent pH indicators include any element or matter whose pKa is in a range of acidity corresponding to the proton concentration generated by the half-cell reaction, such as a pH sensitive dye. Sources of pH sensitive dyes include Aldrich of St. Louis, Mo. or Molecular Probes Inc. of Eugene, Oreg. One such pH sensitive dye comprises 3-(2-pyridyl)-[1,2,3]-triazolo [1,5a]pyridine (PTP). Examples of other types of fluorescent pH indicators include quinine, Eosin B, Eosin Y, and Fluorescein. Eosin B and Eosin Y both comprise disodium salts. A UV lamp is necessary to illuminate the florescent pH indicator fixed membrane. The preferred type of UV lamp is a black lamp and a preferred range of wavelengths comprises at least about 250 nm and no more than about 400 nm. One source of a suitable UV lamp is Fisher Scientific of Springfield, N.J.

Another example of a suitable indicator for an indicator fixed membrane would be a calorimetric dye. Preferably, the calorimetric dye fixed membrane will change color upon transfer of the sample (proton, electron, or reduced specie) into the membrane. For example, upon the diffusion of protons, the colorimetric dye fixed membrane may change colors from clear to a particular color (e.g., red or green) or vice versa at the localized areas of proton diffusion. In another embodiment, the calorimetric dye fixed membrane may change from one color to another color such as from red to green upon the proton diffusion. Phloxine B from Aldrich Chemical Co. is one example of a suitable colorimetric dye for indicator fixed membranes. In a generic sense, Phloxine B comprises spiro[isobenzofuran-1(3H), 9′-[9H]xanthen-3-one, 2′4′5′7′-tetrabromo-4,5,6,7-tetrachlor-3′6′-dihydroxy-,disodium salt.

Preferably, the colorimetric dye fixed membrane does not require the presence of a UV lamp to observe the aforementioned color change. Preferably, the lighting available is ambient or room light available from any type of common household light bulb or sunlight. Therefore, a potential advantage to using a calorimetric dye as an indicator is that a UV lamp would not be needed.

In yet another embodiment, the indicator for the indicator fixed membrane may comprise a potentiometric dye to measure a current generated from the reaction that takes place at the catalyst. Also various types of hardware that may be used to detect a change in the membrane include a digital still camera, a digital movie camera, a CCD camera, a fluorescent microscope with or without a band pass filter, or an imaging microscope wavelength light detector such as a Near-field Scanning Optical Microscopy (NSOM). An advantage of the hardware is that the hardware is able to detect a change in this specific indicator fixed membrane with higher resolution than that of the human eye.

In another embodiment, the indicator fixed membrane can be a indicator attached membrane. To create an indicator attached membrane, a dye adsorbed membrane is created and then taken through an additional processing step to chemically bond the dye to the functionalized side chains of the polymer electrolyte membrane before the hydrolysis step.

In an additional embodiment, an indicator fixed membrane can be created through solution casting. This process comprises mixing a solution of the membrane polymer with an indicator solution and subsequently casting the mixture to form a membrane.

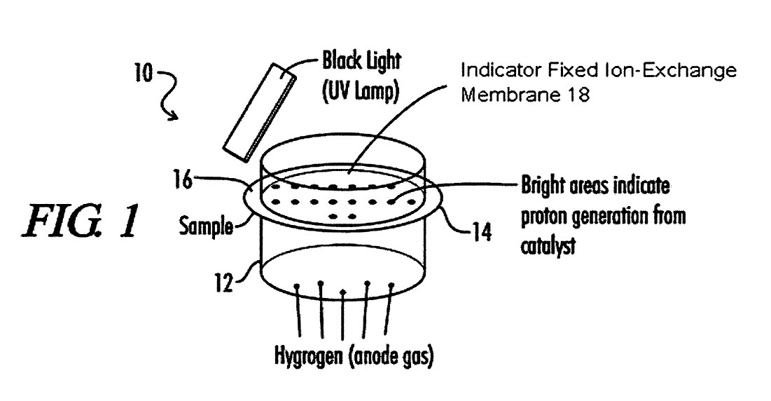

The invention will be further described in regards to the accompanying drawings. Whenever possible, like or the same reference numerals may be used to describe like or the same elements. Illustrated in FIG. 1 is a schematic representation of a fuel cell testing device, generally designated 10. The embodiment of device 10 illustrated in FIG. 1 is an electrochemical cell allowing the anode half-cell reaction of preferably, but not limited to, H₂→2H⁺+2e⁻. In the same manner the half-cell reaction of other proton generating fuels can be utilized for any PEM reaction, such as methanol (MeOH). The aforementioned reaction may also be known as the anode reaction or an oxidation reaction. The invention is not limited to the aforementioned reaction. The invention is equally applicable to a cathode half-cell reaction, such as, but not limited to, 2H⁺+O⁻²→H₂O. The cathode half-cell reaction may also be known as a reduction reaction or cathode reaction.

Device 10 includes a source of an ionizable fluid capable of undergoing oxidation or reduction. One example of a fluid able to undergo an oxidation reaction comprises hydrogen. An example of a fluid capable of undergoing reduction comprises a proton such as H⁺. Preferably, the hydrogen gas was generated from an electrolyzer, not shown in FIG. 1. Other sources of the fluid may also be used. For example, if the fluid comprises oxygen, potential sources include air and bottled oxygen. Additionally, humidity could be a potential source for oxygen or hydrogen. Fluid is used herein to mean a composition of matter that is either in the gas phase, liquid phase, or some combination of both. As shown in FIG. 1, fluid may be passed through a fluid entrance port 12. Preferably fluid entrance port 12 includes a flange 14.

A half-cell electrode assembly 16 capable to receive the fluid is aligned to receive the fluid. Preferably assembly 16 is able to generate a proton or able to reduce a proton, as described above. Furthermore, the aforementioned half-cell oxidation or reduction reaction takes place at assembly 16. Preferably, assembly 16 includes a catalyst for one of the aforementioned oxidation or reduction reactions.

Examples of suitable catalysts comprise transition metals, preferably noble metals, such as platinum, gold, silver, palladium, ruthenium, rhodium, osmium, and iridium, and combinations thereof. A preferred catalyst is platinum black on carbon, or platinum/ruthenium on carbon.

Optionally, assembly 16 may also include a fluid permeable element. The fluid permeable element may be an integral part of assembly 16 or, alternatively, adjacent to the catalyst. It is preferred that the fluid permeable member and the catalyst are in communication, meaning that the fluid can be passed from the fluid permeable member to the catalyst. Preferably, the fluid permeable element comprises at least one of a gas diffusion layer, a gas diffusion substrate, flow field plate, and combinations thereof. Preferably, the gas diffusion substrate comprises at least one of a sheet of flexible graphite, a carbon fiber paper, a composite of flexible graphite and a polymer, a composite of carbon and a polymer, and a composite of flexible graphite, carbon, and a polymer. Examples of suitable polymers include phenolic resins, acrylic resins, and epoxy resins. Optionally, the polymer may be in the form of a fiber or a perforated sheet. One example of flexible graphite is GRAFCELL™, from Graftech Inc. of Lakewood, Ohio. Optionally, the sheet of flexible graphite may have at least one perforation, preferably a plurality of perforations. Preferably, the perforation is aligned in communication with the catalyst. Optionally, the gas diffusion layer may comprise a carbon coating, a carbon black coating, a polytetrafluoroethylene coating or mixtures thereof. Optionally, in the case of the oxidation reaction, it is preferred that assembly 16 performs the function of removing the electrons (e⁻) from device 10. One technique to remove the electrons from device 10 is to ground device 10.

In addition to the catalyst and the optional fluid permeable element, device 10 may also include a membrane (also referred to as an electrolyte). For additional background regarding the catalyst, the fluid permeable element, the membrane, or other basic elements of an electrochemical fuel cell, the specifications of U.S. Pat. Nos. 4,988,583 and 5,300,370 and PCT WO 95/16287 are incorporated herein by reference in their entirety.

Preferably, the membrane of device 10 is included as an indicator fixed ion-exchange membrane 18, the membrane signaling a change in acidity. It is preferred that indicator fixed ion-exchange membrane 18 is in communication with assembly 16. Communication is used herein to mean that matter may flow into assembly 16 and at least the desired material (e.g., proton, electron, or reduced specie) may pass into indicator fixed ion-exchange membrane 18. The desired material may also be referred to as the product of the reaction or the “sample.” The sample is used herein to describe the proton generated or the compound reduced depending on whether the half-cell reaction is a cathode reaction or an anode reaction.

In one embodiment, indicator fixed ion-exchange membrane 18 comprises a fluorescent pH indicator fixed onto a perfluorocarbonsulfonic acid-based ionomer membrane and an UV lamp aligned to fluoresce an available concentration gradient in indicator fixed ion-exchange membrane 18. Preferred types of the fluorescent pH indicator to fix onto the ion-exchange membrane include any element or matter that is able to detect a pKa range of acidity that is generated by the half-cell reaction such as a pH sensitive dye. Sources of pH sensitive dyes include Aldrich of St. Louis, Mo. or Molecular Probes Inc. of Eugene, Oreg. One such pH sensitive dye comprises quinine. Examples of other types of fluorescent pH indicators include Eosin B, Eosin Y, and Fluorescein. Eosin B and Eosin Y both comprise disodium salts. A preferred type of UV lamp is a black lamp and a preferred range of wavelengths comprises at least about 250 nm and no more than about 400 nm. One source of a suitable UV lamp is Fisher Scientific of Springfield, N.J.

Another example of a suitable indicator for an indicator fixed ion-exchange membrane 18 would be a colorimetric dye. Preferably, the colorimetric dye will change color upon transfer of the sample (proton, electron, or a reduced specie) within indicator fixed ion-exchange membrane 18. For example, upon the aforementioned transfer of the sample, the calorimetric dye fixed ion-exchange membrane may change colors from clear to a particular color (e.g., red or green) or vice versa. In another embodiment, the calorimetric dye fixed ion-exchange membrane may change from one color to another such as from red to green upon the transfer. Phloxine B from Aldrich Chemical Co. is one example of a suitable colorimetric dye. In a generic sense, Phloxine B comprises spiro[isobenzofuran-1(3H), 9′-[9H]xanthen-3-one, 2′4′5′7′-tetrabromo-4,5,6,7-tetrachlor-3′ 6′-dihydroxy-,disodium salt.

Preferably, the colorimetric dye fixed ion-exchange membrane does not require the presence of a UV lamp to observe the aforementioned color change. Preferably, the lighting available is ambient or room light available from any type of common household light bulb or sunlight. Therefore, an advantage to using a calorimetric dye as the indicator for an indicator fixed ion-exchange membrane 18 is that a UV lamp would not be needed.

In another embodiment, indicator fixed ion-exchange membrane 18 may comprise a potentiometric dye fixed to an ion-exchange membrane to measure a current generated from the material generated from the catalysis of the ionizable fluid. Also various types of hardware that may be used to detect a change in indicator fixed ion-exchange membrane 18 include a fluorescent microscope with or without a band pass filter, or an imaging microscope wavelength light detector such as a Near-field Scanning Optical Microscopy (NSOM). An advantage of the hardware is that the hardware is able to detect a change in indicator fixed ion-exchange membrane 18 with higher resolution than that of the human eye.

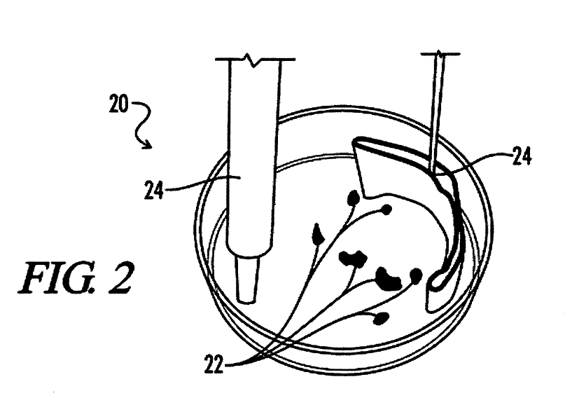

This device may also allow for the visual observation of at least one concentration gradient of the sample in the indicator fixed ion-exchange membrane 18. This is illustrated in FIG. 2, generally designated 20. Depicted in FIG. 2 is a top view of the indicator fixed ion-exchange membrane 18 having areas of change in acidity represented by circled concentration gradients 22 of protons in indicator fixed ion-exchange membrane 18. Gradient 22 may be in one or more of the three geometrical dimensions relative to assembly 16.

As depicted in FIG. 2, blue fluorescence (gradients 22), from a quinine fixed ion-exchange membrane with no proton generating species or solvent, is seen in active areas along the surface of indicator fixed ion-exchange membrane 18. In FIG. 2, electrodes 24 in the solution were not applying a bias on the sample. However, FIG. 2 does demonstrate how alternate electrochemical diagnostics can be incorporated into the invention, such as, open circuit potential vs. time or cyclic voltammetry. One advantage of having electrodes 24 contacting indicator fixed ion-exchange membrane 18 is that the electrochemical response during operation may be measured, such as by measuring impedance or current.

The method may further include the step of altering the design of assembly 16 based on at least one of the results of the observing step. A non-exhaustive list of changes to assembly 16 includes changes to the gas diffusion layer, changes to the gas diffusion substrate, and changes to the gas delivery system (e.g., flow field plate). Examples of changes in the gas diffusion layer and gas diffusion substrate include changes in the choice of materials, pattern of openings in either the layer or the substrate, the sizes of the holes or porosity in either the layer or the substrate, and composition of either the layer or the substrate. Changes to the gas delivery system may include the design of the channels in the flow field plate, changes in the composition of the flow field plate, or changes in the thickness of the flow field plate.

The invention further includes a method for selecting a fluid permeable element for a proton exchange membrane fuel cell. The method includes the step of flowing the fluid through half-cell electrode assembly 16 to form a sample. The sample contacts indicator fixed ion-exchange membrane 18. A change in acidity in indicator fixed ion-exchange membrane 18 is detected. Preferably at least one concentration gradient 22 of the sample is observed in indicator fixed ion-exchange membrane 18. Preferably, gradient 22 is on the visible surface of the indicator fixed ion-exchange membrane 18. Preferably, the aforementioned steps regarding the method of selecting are conducted on a plurality of the half-cell electrode assemblies 16. The half-cell electrode assembly 16 from the plurality displaying a desired concentration gradient of the sample, in indicator fixed ion-exchange membrane 18 is selected. In the case of multiple assemblies 16 all displaying desired gradients 22, the assembly 16 with the gradient 22 that has the highest color intensity is selected. Techniques to judge intensity include visualization or the below noted spectroscopy and digital image capture techniques. This method may also be used to determine a preferred fluid delivery system for a fuel cell, which multiple fluid delivery systems are proposed.

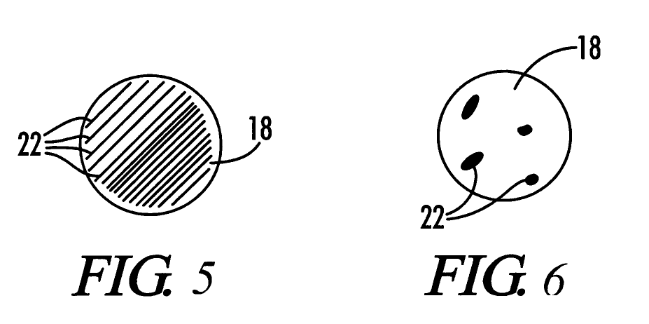

An example of what is meant by “most uniform concentration of the sample in indicator fixed ion-exchange membrane 18” is shown in FIGS. 5 and 6. FIGS. 5 and 6 are top views of indicator fixed ion-exchange membrane 18 for two different assemblies 16. The dark areas in each of FIGS. 5 and 6 represent concentration gradients 22. As depicted in FIG. 5, concentration gradients 22 has a pattern across a top surface of the indicator fixed ion-exchange membrane 18 resulting from the testing of the assembly 16 for FIG. 5. In contrast, testing of assembly 16 for FIG. 6 resulted in four (4) random locations of gradients 22 on a top surface of the indicator fixed ion-exchange membrane 18. Thus, the assembly, which exhibited the most uniform concentration of the sample in the indicator fixed ion-exchange membrane 18 between FIGS. 5 and 6, was FIG. 5. Therefore, in selecting an assembly 16, the person of ordinary skill in the art should select the assembly associated with FIG. 5. Optionally, the method may further comprise forming the half-cell electrode assembly 16 with the most uniform concentration of the sample in the indicator fixed ion-exchange membrane 18 into a fuel cell. Optionally again, the same indication fixed ion-exchange membrane can be utilized as the membrane for the selected assembly.

The spatial resolution of active surface regions (also referred to as gradients 22) of the indicator fixed ion-exchange membrane 18 demonstrates an aspect of the usefulness of this invention. The spatial resolution of gradients 22 in the indicator fixed ion-exchange membrane 18 can be used to develop an understanding of how material modifications can affect gas diffusion, catalyst efficiency, proton diffusion, and the interplay between gas diffusion, catalyst efficiency and proton diffusion.

The invention may also be used to evaluate material property differences as can be seen upon comparison of material types such as, for example, carbon fiber paper versus flexible graphite sheets. The invention may be used to predict morphology differences, such as micro porosity and pore size distribution, and to evaluate differences in the diffusion of gas and subsequent delivery to the catalyst layer.

Furthermore, this invention allows for the evaluation of fuel cell components without the complication of additional testing materials. The indicator fixed membrane can possibly replace the membrane used in an existing fuel cell or be used entirely in commercial applications.

Yet furthermore, this inventive membrane simplifies the testing of fuel cell components by providing one skilled in the arts with a method of testing the performance of a complete fuel cell with only the addition of an extra electrode and gas diffusion layer.

Many aspects of PEM fuel cell materials, components, and/or operational parameters can be evaluated with this invention, such as:
a) Gas Diffusion Substrate morphology changes, and/or material changes,
b) Catalyst uniformity, deposition procedure, composition, or ink formulation,
c) Diagnostic outputs for anode or cathode half reaction:
   a. Current collection/generation,
   b. Reactant/byproduct mass transfer, and
   c. Electrode testing and efficiency—i.e., polarization curves.
d) Flow field & MEA designs related to gas delivery to the MEA,
e) Application to alkaline cells and other industrially relevant electrochemical reactions,
f) Improved spatial resolution via Near-field Scanning Optical Microscopy and Fluorescent Imaging techniques, among other imaging or spectroscopic techniques,
g) PEM fuel cell applications—not just hydrogen but alcohol (direct methanol, etc.), acetic acid, formic acid, etc., any PEM reaction, and
h) Intrinsic material property changes during fuel cell operation such as electrical conductivity of the GDL substrate.

Considering the anode half-cell reaction in a hydrogen fuel cell (H₂ 2H⁺+2e⁻), it can be imagined that where active catalyst sites convert hydrogen gas into protons, there will be a localized region of higher acidity providing cage escape of the electron to preclude recombination with the protons. Preventing recombination of the electron with the proton can optionally be achieved by simply grounding the substrate in a closed circuit fashion (with or without external bias). Utilizing a common fluorescent pH indicator, a test cell for visualizing this half-cell reaction can be constructed. In a similar manner, the half-cell reaction of other proton generating fuels can be utilized for any PEM reaction. A converse approach can be taken to construct a test cell for the cathode half reaction, utilizing the consumption of protons as the mechanism for reaction detection, visualization, and measurement. In addition, this invention is intended to describe at least a method to evaluate the following without being limited to the below applications:
1) Gas diffusion layers consisting of various formulations, e.g., diffusion layers composed of a polymer and carbon and/or graphite
2) Diffusion through indicator fixed ion-exchange membranes
3) Substrates for the above—such as but not limited to gas diffusion substrates, membrane electrode assembly components (i.e., carbon fiber paper, fibrous materials, carbon or graphite-based materials, flexible graphite, etc.—with or without incorporation of the proton exchange material
4) MEA assemblies including any or all of the components for comparison such as flow-field plates, gas diffusion substrates, gas diffusion coatings, layers, membranes, catalyst support formulations, catalyst materials, and additives,
5) Flow channel designs,
6) Operational parameters such as fuel and/or oxidant gas pressure, flow rate, and composition,
7) Design and/or performance of gas diffusion substrate morphology or composition (such as fiber papers or perforated GRAFOIL® flexible graphite materials),
8) Design and/or performance of fibrous material morphology or composition (such as but not limited to carbon fiber papers),
9) Design and/or performance of conductive or non-conductive composite materials morphology or composition.
10) Anode or cathode engineering designs,
11) Electron generation or consumption can be spatially “mapped”, and
12) Mass transport of water may be evaluated.

For example, use of the following technique will allow various substrates to be compared such as with an embodiment as shown in FIG. 1 where hydrogen gas was fed into the bottom of apparatus 10. This specific example shown should not limit the general application of this invention for “mapping” the electrochemical activity. Mapping is used herein to mean at least the activity of observing gradients 22 in indicator fixed ion-exchange membrane 18 and the documentation and retention of where gradients 22 appeared in indicator fixed ion-exchange membrane 18 with respect to a particular assembly 16.

The image and visualization such as shown in FIG. 2 will be beneficial for at least engineering a gas diffusion substrate material which is optimized and has uniform gas diffusion resulting in uniform catalyst utilization.

The delivery of gas through flow field channels, through the diffusion substrate, and reaching the catalyst can be visualized with this invention. In practice mathematical modeling can be used to predict beneficial results and to create beneficial designs for flow-field channels. The invention can be used to verify the models and/or to refine the models, thereby leading to better engineering designs. Uniformity of gas delivery to the catalyst can be visualized as above with this invention wherein discrete, localized areas (or localized increased & decreased areas) of proton generation follow the design of the flow channels.

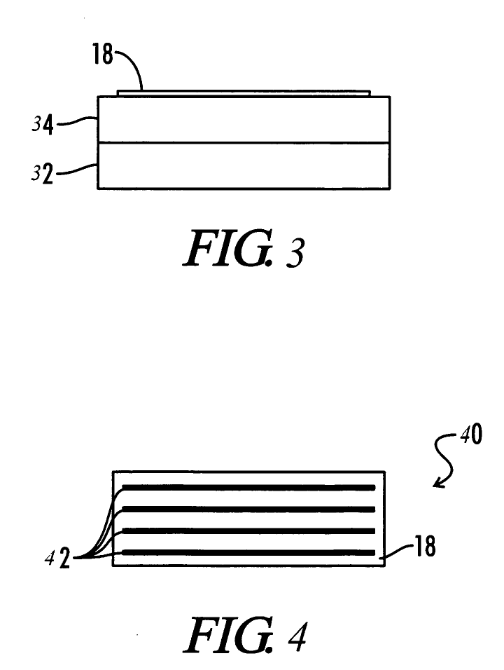

This application is further illustrated in FIGS. 3 and 4. FIG. 3 is a schematic side elevation view of the alignment of a half-cell electrode assembly 16, and indicator fixed ion-exchange membrane 18. Half-cell electrode assembly 16 comprises of a flow field plate 32 with channels (not shown) and a layer 34, which comprises a gas diffusion substrate, gas diffusion layer coating, and a catalyst. Preferably, indicator fixed ion-exchange membrane 18 comprises a material able to indicate the presence of protons through fluorescence.

FIG. 4 is a top view of a surface of indicator fixed proton-exchanged membrane 18 shown in FIG. 5. As depicted in FIG. 4, indicator fixed proton-exchanged membrane 18 includes a plurality of fluorescent areas 42. Each fluorescent area 42 represents an area of changed acidity in indicator fixed ion-exchange membrane 18 due to the presence of at least one proton. FIG. 4 indicates that the fluid is being transmitted through assembly 16 and uniformly contacting the catalyst in linear regions. Additionally, cylindrical fuel cell designs and materials can be analyzed in a similar fashion.

Alternate embodiments of the invention can be utilized by systematically only varying one variable at a time, such as the gas diffusion substrate type, GDL coating type, composition, or morphology. Comparisons can be made that isolate a variable and allow ex-situ testing of that variable or component aside from testing in a fuel cell test station. Furthermore, other materials and/or variables can be isolated and tested in a similar fashion.

It will be apparent to those skilled in the art that various modifications and variations can be made to the present invention without departing from the spirit and scope of the invention. Thus it is intended that the present invention cover the modifications and variations of the invention provided they come within the scope of the appended claims and their equivalents.

What is claimed is:

1. A method for creating an indicator fixed ion-exchange membrane, comprising the steps of:
a) dissolving an indicator into a solvent to create an indicator solution;
b) contacting an ion-exchange membrane with the indicator solution; and
c) fixing the indicator of the indicator solution of step b) throughout the membrane to create an indicator fixed ion-exchange membrane.

2. The membrane of claim 1 wherein the indicator fixed ion-exchange membrane is an indicator attached ion-exchange membrane.

3. The membrane of claim 1 wherein the indicator fixed ion-exchange membrane is an indicator absorbed ion-exchange membrane.

4. The method of claim 1 wherein the ion-exchange membrane is a perfluorocarbonsulfonic acid-based ionomer membrane.

5. The method of claim 1 wherein the indicator of step a) is 3-(2-pyridyl)-[1,2,3]-triazolo [1,5-a]pyridine.

6. The method of claim 1 wherein the indicator of step a) is quinine.

7. The method of claim 1 wherein the solvent of step a) is comprised of methylene chloride, 3,3-dichloro-1,1,1,2,2-pentafluoropropane, and 1,3-dichloro-1,1,1,2,3-pentrfluoropropane.

8. The method of claim 1 wherein step c) comprises heating the contacted membrane to a temperature of from about 25° C. to about 35° C. for from about 70 hours to about 80 hours.

9. The method of claim 1 further comprising:
hydrolyzing the indicator fixed ion-exchange membrane of step c).

10. The method of claim 9 wherein step d) comprises:
d1) stirring the membrane in a solution of aqueous sodium hydroxide and dimethylsulfoxide;
d2) adding additional dimethylsulfoxide to the solution and membrane;
d3) washing the membrane of step d2) with distilled water to create a washed membrane;
d4) drying the washed membrane at room temperature to create a hydrolyzed indicator fixed ion-exchange membrane.

11. A method for creating an indicator fixed ion-exchange membrane, comprising the steps of:
a) dissolving a membrane polymer into a solvent to create a membrane polymer solution;
b) mixing an indicator with the membrane polymer solution to create an indicator and membrane polymer solution; and
c) casting the indicator and membrane polymer solution of step b) to form the indicator fixed ion-exchange membrane.

12. An indicator fixed ion-exchange membrane.

13. The membrane of claim 12 wherein the indicator fixed ion-exchange membrane is an indicator adsorbed ion-exchange membrane.

14. The membrane of claim 12 wherein the indicator fixed ion-exchange membrane is an indicator attached ion-exchange membrane.

15. The membrane of claim 12 wherein the membrane is a perfluorocarbonsulfonic acid-based ionomer membrane.

16. The membrane of claim 12 wherein the indicator is 3-(2-pyridyl)-[1,2,3]-triazolo [1,5-a]pyridine.

17. The membrane of claim 12 wherein the indicator is quinine.

18. The membrane of claim 12 wherein the indicator fixed membrane further comprises an indication of a concentration gradient.

19. The membrane of claim 18 wherein the indication is colorimetric.

20. The membrane of claim 18 wherein the indication is luminescent.

21. The membrane of claim 18 wherein the concentration gradient is comprised of a graduated difference in the concentration of ions in the membrane.

22. A fuel cell testing device comprising:
a) a housing with a fluid entrance port and a visible membrane containment area;
b) a catalyst received at the visible membrane containment area;
c) a source of an ionizable fluid connected to the fluid entrance port so that an ionizable fluid can flow from the source into the housing through the fluid entrance port and react with the catalyst to produce ions;
d) an indicator fixed ion-exchange membrane capable of responding to an ionic concentration gradient, the membrane received at the membrane containment area and in ionic communication with the catalyst; and
e) a fuel cell component received in the housing;
wherein the indicator fixed ion-exchange membrane experiences an ionic concentration gradient and alters its response to light, indicating at least one fuel cell component characteristic.

23. The fuel cell testing device of claim 22 wherein the fuel cell component is selected from the group consisting of a flow field plate, a gas diffusion layer, an electrode, a membrane electrode assembly, a membrane and combinations thereof.
